(19) United States
(12) Patent Application Publication
(10) Pub. No.: US 2026/0067127 A1
(43) Pub. Date: Mar. 5, 2026

(54) IN-VEHICLE NETWORK SYSTEM, RELAY NODE, AND ACTIVATION MESSAGE TRANSFER METHOD

(71) Applicant: DENSO CORPORATION, Kariya-city (JP)

(72) Inventors: Mao YAMAUCHI, Kariya-city (JP); Yasuhiro KOTANI, Kariya-city (JP)

(21) Appl. No.: 19/278,063

(22) Filed: Jul. 23, 2025

(30) Foreign Application Priority Data
Aug. 29, 2024 (JP) 2024-147669

(51) Int. Cl. H04L 12/40; G06F 8/65

(52) U.S. Cl. CPC H04L 12/40039; G06F 8/65; H04L 2012/40273

(57) ABSTRACT

An in-vehicle network system, a relay node, or an activation message transfer method causes an end node to transition from a sleep state to a wake-up state when an activation condition is satisfied and transmit an activation message including activation request information indicating an activation cluster, causes the end node to transition from the sleep state to the wake-up state when receiving the activation message, generates integration activation request information and an integration activation message, and transfers the integration activation message.

### CROSS REFERENCE TO RELATED APPLICATION

The present application claims the benefit of priority from Japanese Patent Application No. 2024-147669 filed on Aug. 29, 2024. The entire disclosure of the above application is incorporated herein by reference.

### TECHNICAL FIELD

The present disclosure relates to an in-vehicle network system.

### BACKGROUND

As a comparative technology, a partial network technology has been known, and the technology selectively controls wake-up/sleep states of each ECU connected to an in-vehicle network system.

### SUMMARY

According to an aspect of the present disclosure, an in-vehicle network system includes at least one of (i) a circuit and (ii) a processor with a memory storing computer program code executable by the processor, the at least one of the circuit and the processor configured to cause the in-vehicle network system to: cause an end node to transition from a sleep state to a wake-up state when an activation condition is satisfied and transmit an activation message including activation request information indicating an activation cluster, cases the end node to transition from the sleep state to the wake-up state when receiving the activation message, generate integration activation request information and an integration activation message, and transfer the integration activation message.

### BRIEF DESCRIPTION OF THE DRAWINGS

FIG. 1 is a block diagram showing a configuration of an in-vehicle network system according to a first embodiment.

FIG. 2 is an explanatory diagram showing a configuration of a network management (NM) message.

FIG. 3 is an explanatory diagram showing an overview of an activation process executed by an activation unit of an end ECU upon receiving the NM message.

FIG. 4 is a flowchart showing a state management process executed by an end ECU.

FIG. 5 is a flowchart showing a message integration process executed by a zone ECU.

FIG. 6 is an explanatory diagram showing an overview of processes in a case of normal state and a case of buffer congestion in a message integration process.

FIG. 7 is a block diagram showing a configuration of an in-vehicle network system according to a second embodiment.

FIG. 8 is an explanatory diagram showing an initial setting of a NM table in each zone ECU.

FIG. 9 is an explanatory diagram showing a setting of the NM table updated by adding the end ECU and updating a program.

FIG. 10 is a block diagram showing a configuration of an in-vehicle network system according to a third embodiment.

FIG. 11 is an explanatory diagram showing a setting of the NM table of each zone ECU.

FIG. 12 is an explanatory diagram showing a case where multiple NM tables prepared in advance are selected and used.

### DETAILED DESCRIPTION

In AUTOSAR R22-11: Specification of UDP Network Management, which is a standard for in-vehicle Ethernet networks, it is defined that end nodes periodically transmit NM (network management) messages to control an activation state, and relay nodes forward NM messages via broadcast. The Ethernet is a registered trademark. That is, each NM message transmitted from each end node is individually transmitted to all end nodes. Therefore, there is a difficulty that the amount of communication of NM messages transferred in the network becomes huge.

One aspect of the present disclosure provides a technology for reducing a communication amount of messages related to control of an activation state of a partial network.

According to one aspect of the present disclosure, an in-vehicle network system includes multiple relay nodes and multiple end nodes. Each relay node includes multiple communication ports. Each end node is connected to one of the multiple relay nodes. Each communication port of the multiple relay nodes is connected to a different relay node among the multiple relay nodes or an end node subordinated to the multiple relay nodes among the multiple end nodes. The end node includes an activation unit. When an activation condition is satisfied in the end node, the activation unit transitions from the sleep state to the wake-up state and transmits an activation message including an activation request information indicating the activation cluster to which the end node belongs. Further, when the end node receives the activation message including the activation request information indicating the activation cluster to which the end node belongs, the end node transitions from the sleep state to the wake-up state. The relay node includes a message integration unit and a port transfer unit. The message integration unit is configured to merge the activation request information indicated in an integration target message that is the activation message received from, among the multiple end nodes, a subordinate end node during a predetermined buffering period to generate integration activation request information, and generate an integration activation message that is the activation message including the integration activation request information. The port transfer unit is configured to transfer the integration activation message generated by the message integration unit to, among the multiple communication ports, a communication port other than a communication port that received the integration target message.

According to such a configuration, the activation message is not transferred as is, and the integrated activation message in which the multiple activation messages are integrated is transferred. Therefore, it may be possible to reduce the amount of communication related to the activation message between the relay node and the relay node and between the relay node and the end node. As a result, it may be possible to reduce the processing load related to the duplicate activation message in the relay node and the end node, and reduce the power consumption by reducing unnecessary node activation.

According to one aspect of the present disclosure, a relay node forming an in-vehicle network system with a different relay node and multiple end nodes. The relay node includes multiple communication ports connected to the different relay node or an end node subordinated to the relay node among the multiple end nodes. The relay node includes a message integration unit and a port transfer unit. The message integration unit and the port transfer unit are similar to the description in the in-vehicle network system described above.

According to such a configuration, it can be used as a relay node configuring the in-vehicle network system described above. According to one aspect of the present disclosure, a transfer method of an activation message is applied to a relay node that forms an in-vehicle network system with a different relay node and multiple end nodes. The relay node includes multiple communication ports connected to the different relay node or the end node under its control. The transfer method of an activation message includes: merging the activation request information indicated in the integration target message that is the activation message received from, among the multiple end nodes, a subordinate end node during a predetermined buffering period to generate the integration activation request information; and generating an integration activation message including the activation request information. Further, the activation message transfer method includes transferring the generated integration activation message to a communication port other than a communication port that received the integration target message. The definitions of the terms in the activation message transfer method are similar to those described in the in-vehicle network system described above.

By performing such a method, it may be possible to obtain the similar effects to those obtained by the in-vehicle network system described above.

Hereinafter, embodiments of the present disclosure will be described with reference to the drawings.

### 1. First Embodiment

### 1-1. Configuration

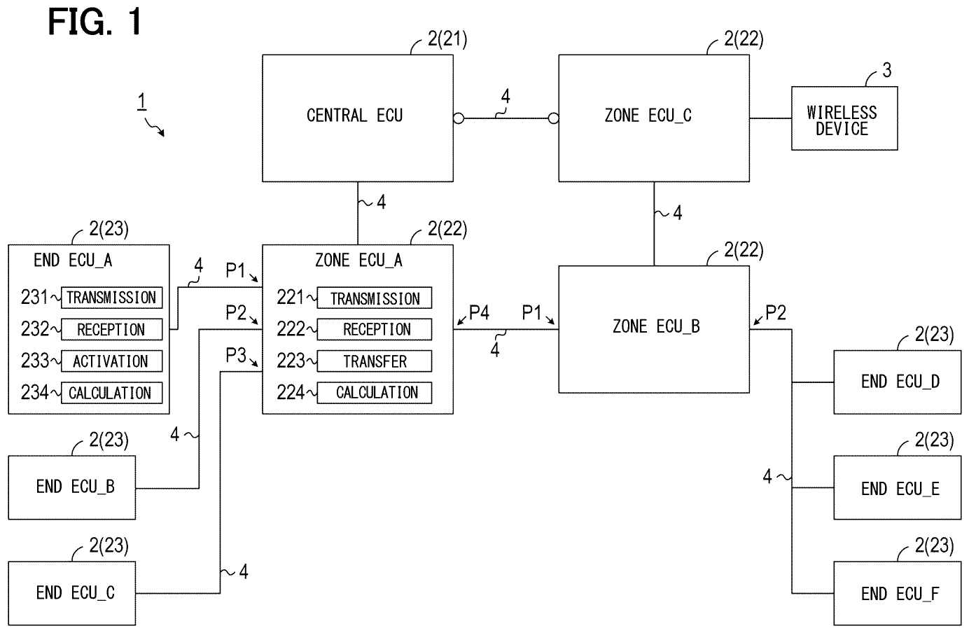

An in-vehicle network system 1 shown in FIG. 1 is connected to multiple electronic control units (hereinafter referred to as ECUs) 2 mounted on a vehicle via multiple transmission paths 4 that communicate using an Ethernet protocol. The Ethernet is a registered trademark.

The ECU 2 has a wake-up state, which is a normal operation state in which its own functions can be executed without limitation, and a sleep state, which is a low power consumption operation state in which at least a part of its own functions are limited. The operation state of the ECU 2 is individually controlled using the NM message. The NM is an abbreviation for Network Management. That is, the in-vehicle network system 1 is configured as a partial network (hereinafter referred to as PN). Further, in the sleep state, the ECU 2 has at least a function of receiving the NM message and transitioning the own ECU 2 to the wake-up state in accordance with the content of the NM message.

The multiple ECUs 2 are classified into a central ECU 21, multiple zone ECUs 22, and multiple end ECUs 23. The central ECU 21 forms a communication network including multiple zone ECUs 22 and redundant routes. The central ECU 21 controls the multiple zone ECUs 22 and implements a coordinated control of the entire vehicle.

The zone ECU 22 is provided for each zone in which an area in the vehicle is divided. Each zone ECU 22 is connected to multiple end ECUs 23 existing in the zone via individual transmission paths 4. The zone ECU 22 controls subordinate end ECUs 23 directly connected to the zone ECU to implement coordinated control in the zone.

In the present embodiment, the vehicle is divided into three zones A to C, and the zone ECUs 22 placed in each zone A to C are referred to as a zone ECU_A, a zone ECU_B, and a zone ECU_C. Note that the number of zones is not limited to three, and the vehicle may be divided into four zones: the front of the vehicle, the rear of the vehicle, one on the side of the vehicle, and the other on the side of the vehicle. Further, it may be divided into five or more zones.

As shown in FIG. 1, the central ECU 21 is connected to the zone ECU_A and the zone ECU_C via individual transmission paths 4. The zone ECU_A is connected to the central ECU 21 and the zone ECU_B via individual transmission paths 4. The zone ECU_B is connected to the zone ECU_A and the zone ECU_C via individual transmission paths 4. The zone ECU_C is connected to the zone ECU_B and the central ECU 21 via individual transmission paths 4. That is, although the central ECU 21 and the multiple zone ECUs 22 are connected in a loop shape, a part of the communication port connected to the transmission path 4 is set to a blocking port, and thereby the travel of the communication frame is prevented. FIG. 1 shows a case where the communication port connecting the central ECU 21 and the zone ECU_C is set to a blocking port. Communication with the blocking port may be prohibited under normal states, and the prohibition may be released in the event of a failure of the ECU 2, the transmission path 4, or the like. That is, the blocking port may be used to ensure redundancy of the communication path. The central ECU 21 and the multiple zone ECUs 22 may be referred to as forming a ring topology.

Three end ECUs 23 are connected to the zone ECU_A in a star shape via individual transmission paths 4. Hereinafter, the end ECU 23 connected to the zone ECU_A is also referred to as an end ECU_A, an end ECU_B, and an end ECU_C. The zone ECU_A and the end ECUs_A to C form a switched network (hereinafter referred to as switched NW). Note that the number of end ECUs 23 connected as subordinates in each zone ECU 22 is not limited to the above example, and is arbitrary.

Three end ECUs 23 are connected to the zone ECU_B in a bus shape via one transmission line 4. Hereinafter, the end ECU 23 connected to the zone ECU_A is also referred to as an end ECU_D, an end ECU_E, and an end ECU_F. That is, the zone ECU_B and the end ECUs_D to F form the bus NW.

The zone ECU_C is connected to a wireless device 3 that communicates with a server or the like on a wide area wireless network. Further, the zone ECU_C may also be connected to one or more end ECUs 23, but for simplicity, the illustration and description thereof will be omitted here.

### 1-2. NM Message

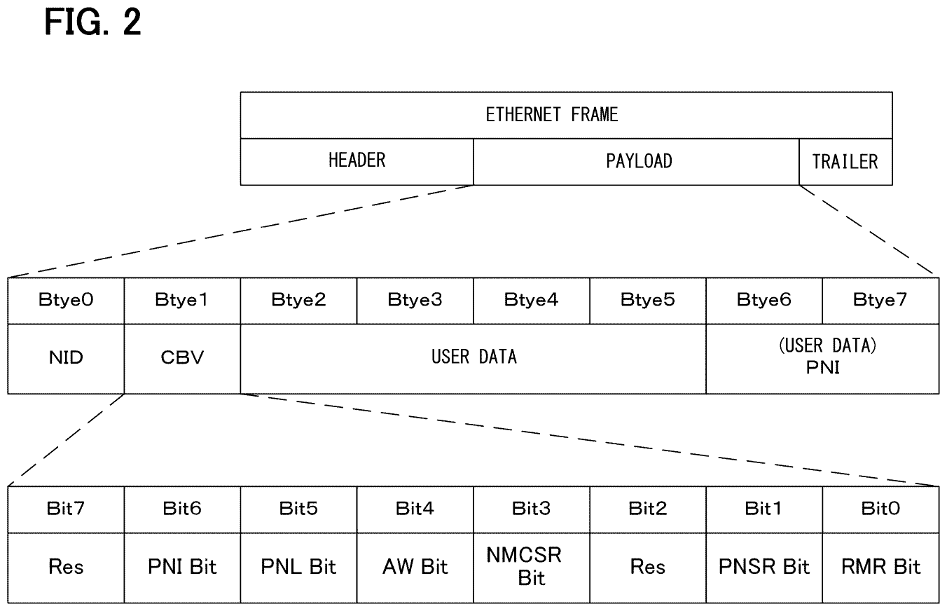

An overview of the NM message will be described with reference to FIG. 2. Note that the NM messages comply with the specifications defined in AUTOSAR R22-11: Specification of UDP Network Management. Note that the applicable specifications are not limited to R22-11. For example, a subsequent version such as R23-11 may also be used.

The NM message is transmitted and received using an Ethernet frame. The Ethernet frame includes a physical header, an Ethernet header, a payload, and a trailer. The physical header is a preamble. The Ethernet header includes a destination address, a transmission source address, and the like. The payload is data, and an NM message is installed. The trailer is a frame check sequence.

The NM message includes a NID, CBV, user data, and PNI. The NID and the CBV are provided by one byte. The user data is variable bytes, and FIG. 2 shows a case of 4 bytes. The PNI is a variable byte, and in FIG. 2, the PNI indicates a case of two bytes. The positions of the NID and CBV in the NM message may be reversed.

The NID is an abbreviation for Node Identifier, and is information that identifies the node (that is, the end ECU 23) that is the transmission source of the NM message. The user data is an area where arbitrary data can be set by the user.

The PNI is an abbreviation for Partial Network Information. The PNI is set in the area of user data and represented by multiple bits. Each bit constituting the PNI is called a PNC bit. The PNC is an abbreviation for Partial Network Cluster. The PNC indicates a group (hereinafter referred to as a PN cluster) of end ECUs 23 that need to be activated at the same time of the node (that is, the ECU 2). Each PNC bit is assigned a different PN cluster. A PNC bit whose value is set to 1 indicates that a factor for waking up the PN cluster associated with the PNC bit is occurring. A PNC bit whose value is set to 0 indicates that there is no factor causing the PN cluster associated with the PNC bit to wake up. Hereinafter, the PNI included in the NM message to wake up the ECU 2 will be referred to as PN request information.

The CBV is an abbreviation for Control Bit Vector, which is information indicating the contents of instructions by NM messages. The CBV includes a PNI bit, a PNL bit, an AW bit, a NMCSR bit, a PNSR bit, and a RMR bit.

The PNI bit is information indicating whether partial network management (hereinafter referred to as partial NM) is supported. In the present embodiment, the PNI bit is fixed to a value indicating that it supports NM. When it is compatible with NM, the user data of the NM message includes PN request information.

The PNL bit is information indicating whether the message is the NM message for PNC learning. The PNL is an abbreviation for Partial Network Learning. The AW bit is information indicating whether the node wake-up is based on a request from inside the node or from outside the node. The AW is an abbreviation for Active Wakeup.

The NMCSR bit is information indicating whether a synchronous shutdown (hereinafter, synchronous shutdown) of the entire network is required. The NMCSR is an abbreviation for NM Coordinator Sleep Ready.

The PNSR bit is information indicating whether the NM message includes a request for synchronous shutdown. The PNSR is an abbreviation for PN Shutdown Request. The RMR bit is information indicating whether transition to the repeat message state is required. It is used when various information is collected using NM messages. The RMR is an abbreviation for Repeat Message Request.

### 1-3. End ECU

As shown in FIG. 1, the end ECU 23 includes a transmission unit 231, a reception unit 232, an activation unit 233, and a calculation unit 234.

The transmission unit 231 has a function of transmitting a message generated by the own end ECU 23. The reception unit 232 has a function of receiving messages from other ECUs 2. The activation unit 233 has a function of transitioning the own end ECU 23 to the wake-up state based on the NM message received by the reception unit 232 when the own end ECU 23 is in the sleep state.

The calculation unit 234 has at least a function of monitoring transmission and reception of NM messages while the own end ECU 23 is in the wake-up state, and transitioning the own end ECU 23 to the sleep state as necessary.

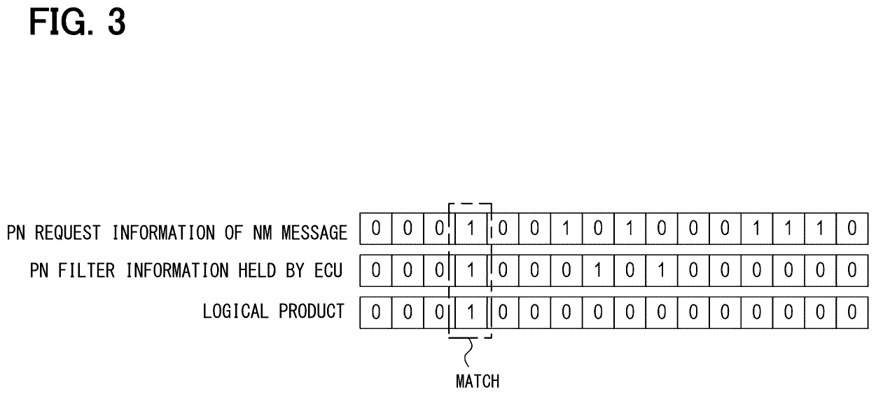

The end ECU 23 holds a PNI (hereinafter, PN filter information) in which all the PNC bits corresponding to the PN cluster to which the own end ECU 23 belongs are set to 1. When the activation unit 233 receives an NM message (hereinafter referred to as a wake-up request) including the PN request information, as shown in FIG. 3, the activation unit 233 compares the PN request information indicated in the wake-up request with the PN filter information of the own end ECU 23 bit by bit. As a result of the comparison, when there is even one matching bit, the activation unit 233 transitions the own end ECU 23 from the sleep state to the wake-up state. The comparison between the PN request information and the PN filter information may be performed by obtaining a logical AND of the two information. In this case, when the logical AND result is non-zero, the PN request information indicates the PNC to which the own end ECU 23 belongs, in other words, it is determined that a factor for waking up the own end ECU 23 has occurred.

The activation unit 233 may be configured by hardware. When the activation condition is satisfied, the activation unit 233 transitions the subject end ECU 23 from the sleep state to the wake-up state. The activation condition includes at least extracting a wake-up factor (hereinafter referred to as an external factor) based on the received NM message. Further, the activation condition may include the occurrence of a wake-up factor (hereinafter referred to as an internal factor) in the end ECU 23. The activation unit 233 may have a function of notifying the calculation unit 234 of information indicating whether the transition from the sleep state to the wake-up state is due to an external factor or an internal factor.

The calculation unit 234 includes a computer equipped with a CPU and a memory. When the end ECU 23 transitions to the wake-up state, the calculation unit 234 at least executes the state management process. The state management process is a process of maintaining the wake-up state, transitioning to the sleep state, or managing the operation state of the end ECU 23.

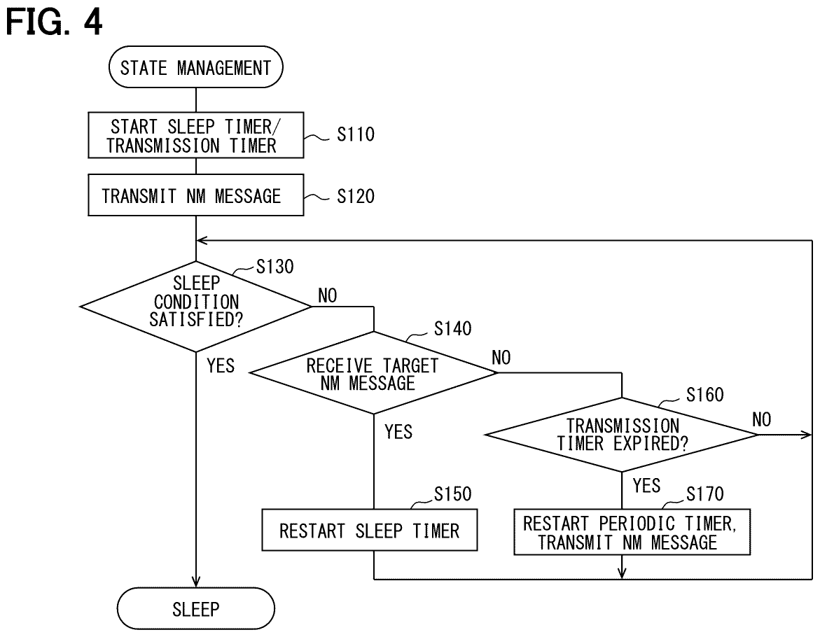

The state management process executed by the calculation unit 234 of the end ECU 23 will be described with reference to a flowchart of FIG. 4. In S110, the calculation unit 234 starts the sleep timer and the periodic transmission timer. The sleep timer is a timer related to a sleep condition used when transitioning the subject end ECU 23 from the wake-up state to the sleep state. The sleep timer is set to timeout at, for example, 1 second. The periodic transmission timer is a timer that determines the transmission timing of the NM message. The periodic transmission timer is set to timeout at, for example, 10 milli seconds. The timeout periods of the sleep timer and the periodic transmission timer are not limited to the above settings, and can be arbitrarily set.

In S120, the calculation unit 234 transmits an NM message including the PN filter information of the subject end ECU 23 as the PN request information. Instead of using the PN filter information as the PN request information, a part of the PN filter information may be used as the PN request information depending on the state of the own end ECU 23. For example, the PN cluster to be activated may be different depending on whether the wake-up is caused by an external factor or an internal factor.

In S130, the calculation unit 234 determines whether the sleep condition is satisfied. One of the sleep conditions includes at least the timeout of the sleep timer. When the calculation unit 234 determines that the sleep condition is satisfied, the process ends, and the subject end ECU 23 transitions to the sleep state. When the calculation unit 234 determines that the sleep condition is not satisfied, the process shifts to S140.

In S140, the calculation unit 234 determines whether an NM message (hereinafter referred to as a target NM message) having PN activation information in which the PNC bit corresponding to the PN cluster to which the subject end ECU 23 belongs is set to 1 has been received. When the calculation unit 234 determines that the target NM message has been received, the process shifts to S150. When the calculation unit 234 determines that the target NM message has not been received, the process shifts to S160.

In S150, the calculation unit 234 restarts the sleep timer and returns the process to S130. In S160, the calculation unit 234 determines whether the periodic transmission timer has expired. When the periodic transmission timer has expired, the process shifts to S170. When the periodic transmission timer has not expired, the process returns to S130.

In S170, the calculation unit 234 restarts the periodic transmission timer and transmits the NM message similar to the NM message transmitted in S120, and returns the process to S130.

That is, in the wake-up state, the end ECU 23 transmits the NM message at regular intervals based on the setting value of the periodic transmission timer. Further, when the end ECU 23 does not receive the target NM message for a certain period based on the setting value of the sleep timer, the end ECU 23 enters the sleep state.

### 1-4. Zone ECU

The multiple zone ECUs 22 are all configured in the same manner. As shown in FIG. 1, the zone ECU 22 includes a transmission unit 221, a reception unit 222, a transfer unit 223, and a calculation unit 224.

The transmission unit 221 has a function of transmitting a message via any of the multiple communication ports of the subject zone ECU 22. The reception unit 222 has a function of receiving messages from other ECUs 2 via any of the multiple communication ports of the subject zone ECU 22.

The transfer unit 223 has a function of transferring messages other than the NM message received from the other ECUs 2 according to the destination indicated in the message. The calculation unit 224 merges and integrates the PN request information included in the NM message received from the subordinate end ECU 23, and has a function of transferring the NM message (hereinafter, integrated NM message) including the integrated PN request information to the different ECU 2.

Similarly to the calculation unit 234 of the end ECU 23, the calculation unit 224 includes a computer including a CPU and a memory. The calculation unit 224 at least executes the message integration process.

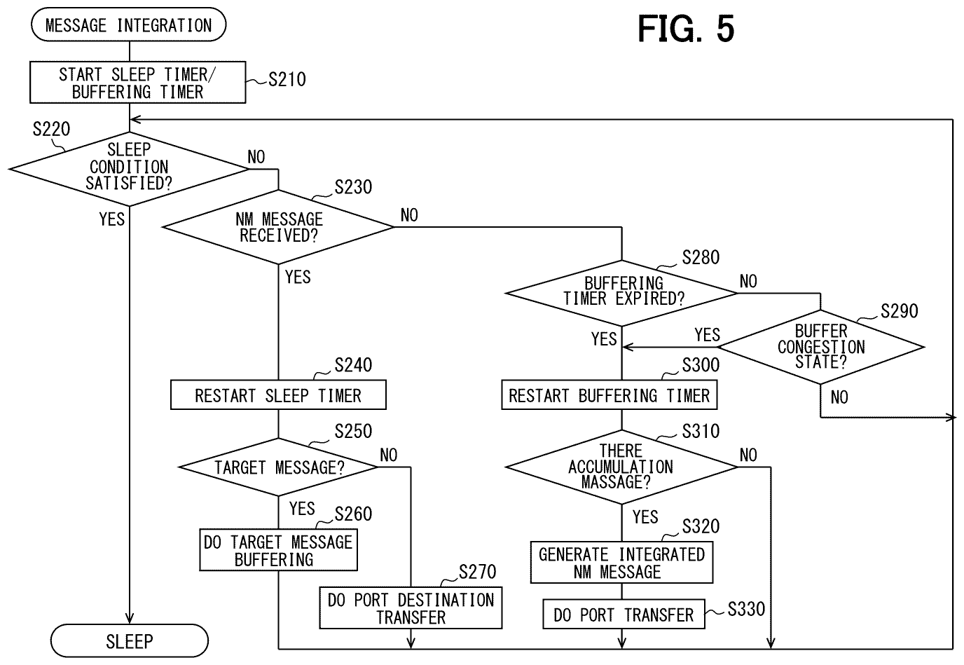

The message integration process executed by the calculation unit 224 when the zone ECU 22 is in the wake-up state will be described with reference to a flowchart of FIG. 5. In S210, the calculation unit 224 starts the sleep timer and the buffering timer. The sleep timer is set similarly to the sleep timer used in the state management process of the end ECU 23. The buffering timer is a timer that determines the buffering period of the NM message. The buffering timer is set, for example, so as to time out at a time equal to or longer than the time at which the periodic transmission timer used in the state management process of the end ECU 23 times out.

In S220, the calculation unit 224 determines whether the sleep condition is satisfied. One of the sleep conditions includes at least the timeout of the sleep timer. When the calculation unit 224 determines that the sleep condition is satisfied, it ends the process and transitions the subject zone ECU 22 to the sleep state. When it determines that the sleep condition is not satisfied, the process shifts to S230.

In S230, the calculation unit 224 determines whether the NM message has been received at any of the communication ports of the subject zone ECU 22. The NM message here includes an NM message from the subordinate end ECU 23 or an integrated NM message transferred from the adjacent zone ECU 22. When the calculation unit 224 determines that the NM message has been received, the process shifts to S240. When the calculation unit 224 determines that the NM message has not been received, the process shifts to S280.

In S240, the calculation unit 224 restarts the sleep timer. In S250, the calculation unit 224 determines whether the received NM message is the accumulation target message. The accumulation target message is an NM message received from the subordinate end ECU 23. When the calculation unit 224 determines that the received NM message is the accumulation target message, the process shifts to S260. When the calculation unit 224 determines that the received NM message is not the accumulation target message, the process shifts to S270. The reasons for excluding the NM messages from the other zone ECUs 22 from the accumulation target are as follows. That is, when the integration target includes the NM message from the other zone ECU 22, the integration NM message that targets all nodes for activation is ultimately generated. That is, the integrated NM message may be sent back to all the end ECUs 23 that are the transmission sources of the NM message, and the effect of preventing unnecessary node activation may be reduced.

In S260, the calculation unit 224 buffers the accumulation target message in the reception buffer, and returns the process to S220. In S270, the calculation unit 224 transfers the non-accumulation target message, which is the NM message that is not the accumulation target message, to all communication ports other than the communication port in which the non-accumulate target message was received among the communication ports of the subject zone ECU 22, and returns the process to S220. The non-accumulation target message is the integrated NM message transferred from another adjacent zone ECU 22.

In S280, the calculation unit 224 determines whether the buffering timer has timed out, that is, whether the buffering period has ended. When the calculation unit 224 determines that the buffering timer has not timed out, the process shifts to S290. When the calculation unit 224 determines that the buffering timer has timed out, the process shifts to S300.

In S290, the calculation unit 224 determines whether the reception buffer of the subject zone ECU 22 is in the congestion state. For example, a state where the reception buffer has less than 10% free space may be determined as the congestion state. When the calculation unit 224 determines that the reception buffer is in the congestion state, the process shifts to S300. When the calculation unit 224 determines that the reception buffer is not in the congestion state, the process returns to S220.

In S300, the calculation unit 224 restarts the buffering timer. That is, the current buffering period ends and a new buffering period starts. In S310, the calculation unit 224 determines whether there is the accumulated NM message in the reception buffer. When there is the accumulated NM message, the process shifts to S320. When there is no accumulated NM message, the process returns to S220.

In S320, the calculation unit 224 generates the integrated NM message based on the NM message accumulated in the reception buffer during the buffering period that ended earlier. Specifically, PN request information is extracted from each NM message stored in the reception buffer. All the extracted PN request information is merged by performing a logical OR operation to generate integrated PN request information. The NM message used to generate the integrated PN request information is deleted from the reception buffer. Then, a new NM message (that is, an integrated NM message) including the generated integrated PN request information is generated.

In S330, the calculation unit 224 transfers the integrated NM message generated in S320 to all communication ports of the subject zone ECU 22 other than the communication port through which the NM message that is the source of the integrated NM message was received, and returns the process to S220.

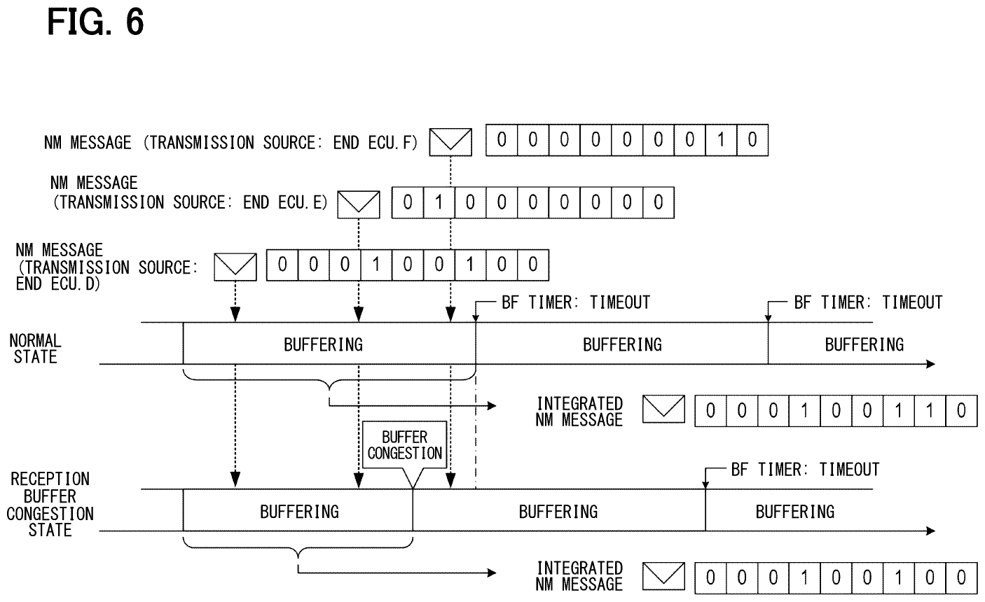

The integration of NM messages in the zone ECU 22 will be described with reference to FIG. 6. FIG. 6 shows a case where the zone ECU_B in FIG. 1 receives a NM message including NM request information from each of its subordinate end ECUs_D to F during the same buffering period. In normal cases where the reception buffer is not congested, after the expiration of the buffering period, the integrated NM message is generated that includes integrated NM request information obtained by performing the logical OR operation on the NM request information.

When the congestion of the reception buffer is detected during the buffering period, the buffering period is forcibly ended, and the integrated NM message is generated according to the NM messages received at the time from the end ECU_D and the end ECU_E.

The generated integrated NM message is transferred to all communication ports connected to other zone ECUs 22 adjacent to the zone ECU_B. On the other hand, in the conventional technology that does not use the integrated NM message, the three NM messages received from the end ECUs_D to F are transferred to all the communication ports connected to the different zone ECU 22 adjacent to the zone ECU_B. That is, in this case, the number of transferred NM messages is ⅓ as compared with the conventional technology.

In addition, the zone ECU_B transfers the integrated NM message received from the adjacent zone ECU 22 (for example, zone ECU_A) to all of the communication ports of the zone ECU_B other than the communication port that received the integrated NM message.

The zone ECU 22 enters the sleep state when there is no reception of either the NM message from the subordinate end ECU 23 or the integrated NM message from the adjacent zone ECU 22 for a certain period based on the setting value of the sleep timer.

### 1-5. Central ECU

The central ECU 21 has the same configuration as the zone ECU 22. However, when there is no end ECU 23 that is a direct subordinate of the central ECU 21, the calculation unit 224 may omit execution of the message integration process.

### 1-6. Correspondence of Terms

In the present embodiment, the central ECU 21 and the zone ECU 22 correspond to relay nodes in the present disclosure, and the end ECU 23 corresponds to an end node in the present disclosure. In the present embodiment, the PN request information corresponds to activation request information of the present disclosure, the PN filter information corresponds to activation filter information of the present disclosure, and the PN cluster corresponds to an activation cluster of the present disclosure. In the present embodiment, the NM message corresponds to an activation message of the present disclosure, and the NM table corresponds to an activation table of the present disclosure. In the present embodiment, the processes in S230 to S260 and S280 to S320 executed by the calculation unit 224 correspond to a message integration unit of the present disclosure, and the process in S330 corresponds to a port transfer unit of the present disclosure.

### 1-7. Effects

According to the first embodiment described above in detail, the following effects are achieved.
(1a) In the in-vehicle network system 1, the zone ECU 22 does not simply transfer the NM message transmitted from the subordinate end ECU 23, but instead creates and transfers an integrated NM message that integrates multiple NM messages received during the buffering period. Accordingly, according to the in-vehicle network system 1, it is possible to reduce the amount of communication of NM messages, and as a result, it is possible to reduce the processing load (for example, unnecessary wake-up) required for NM messages in each ECU 2 and the power consumption.
(1b) In the in-vehicle network system 1, when detecting congestion in the reception buffer, the zone ECU 22 forcibly ends the buffering period and generates the integrated NM message using the NM message buffered at the time. Accordingly, according to the in-vehicle network system 1, it is possible to prevent the reception buffer of the zone ECU 2 from overflowing, and furthermore, prevent the NM message from being discarded without being transferred due to the overflow.
(1c) In the in-vehicle network system 1, the connection between the zone ECU 22 and the subordinate end ECU 23 can be either switched NW or bus NW, so that it is possible to implement cooperative NM operations between different protocols.
(1d) In the in-vehicle network system 1, the wireless device 3 is connected to the network via the zone ECU 22, and is configured as a SDV. The SDV is an abbreviation for Software-Defined Vehicle. Therefore, the in-vehicle network system 1 can not only support OTA software download and update, but also support wake-up instructions from the outside of the in-vehicle network system 1. The OTA is an abbreviation for Over The Air.

### 2. Second Embodiment

### 2.1. Difference from First Embodiment

The fundamental configuration of a second embodiment is similar to that of the first embodiment. Therefore, the difference therebetween will be described below. The same reference numerals as in the first embodiment denote the same elements, and reference is made to the preceding description.

The zone ECU 22 of the first embodiment described above outputs the integrated NM message to all communication ports other than the reception port. The reception port is the communication port that received the integrated NM message or the communication port that received the NM message used to generate the integrated NM message. On the other hand, a zone ECU 22a of the second embodiment differs from the first embodiment in that it extracts the communication port that needs to be transferred using the NM table, and transfers the integrated NM message only to the extracted communication port.

### 2-2. Configuration

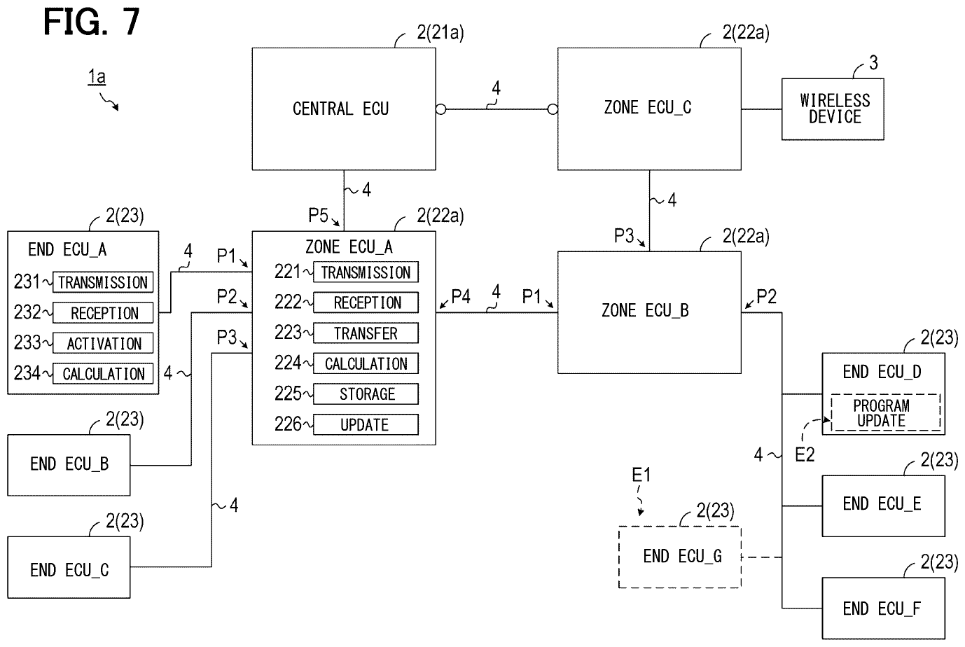

As shown in FIG. 7, in an in-vehicle network system 1a, the ECUs 2 are divided into a central ECU 21a, the zone ECU 22a, and an end ECU 23.

The zone ECU 22a includes a storage 225 and an update unit 226 in addition to the transmission unit 221, the reception unit 222, the transfer unit 223, and the calculation unit 224. The storage 225 stores the NM table.

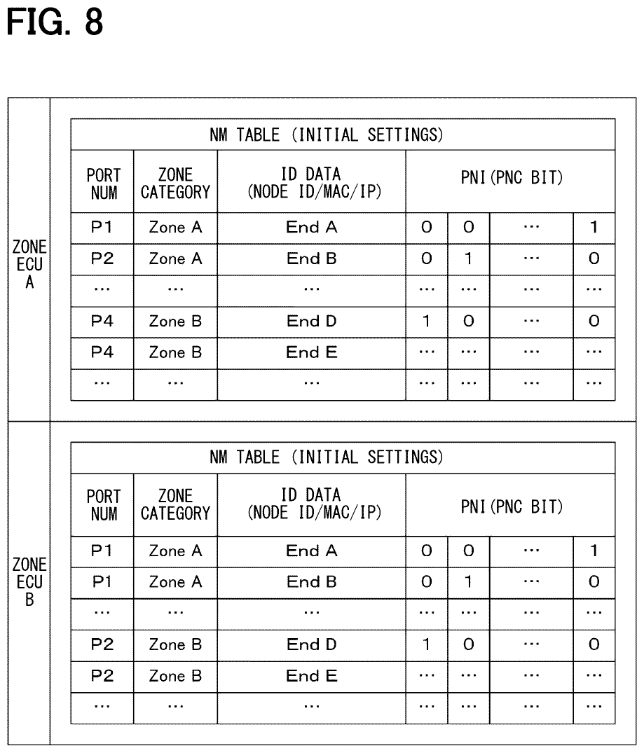

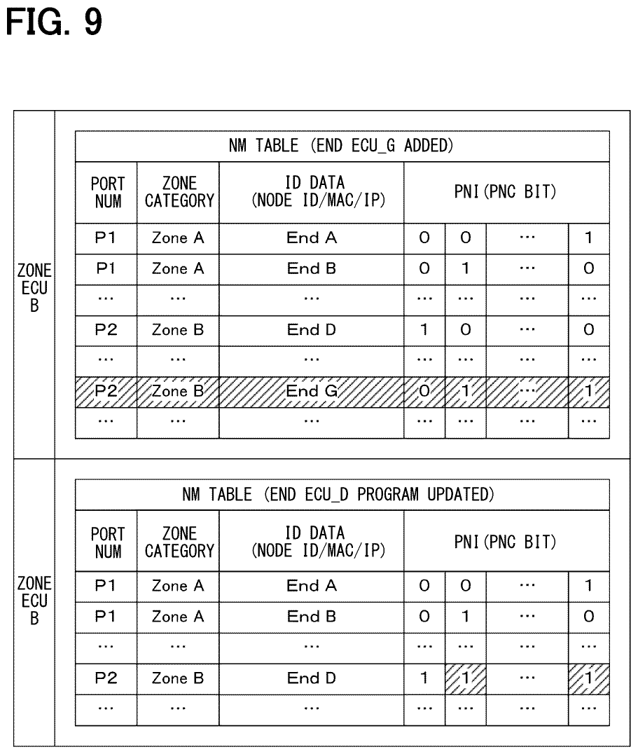

As shown in FIG. 8, the NM table is a collection of data associated with port numbers, zone categories, node identification data, and PN filter information. The node identification data is information that uniquely identifies the end ECU 23. The node identification data may be any of a node ID, a MAC address, and an IP address. The NM table lists node identification data for all end ECUs 23 belonging to the in-vehicle network system 1. In FIG. 8, the entry “End A” shown in the node identification data column indicates “End ECU_A.” Hereinafter, the same applies to FIGS. 9, 11, and 12.

The zone category is information indicating to which zone the end ECU 23 identified by the node identification data (hereinafter referred to as the end ECU 23 to focus on) belongs (i.e., is connected to which zone ECU 22a).

The port number is information that identifies the communication port connected to the end ECU 23 to be focused on or the communication port reaching the zone ECU 22a connected to the end ECU 23. That is, it is information indicating which communication port can be used to reach the end ECU 23 to be focused on.

The PN filter information is a PNI indicating which PNC the focused end ECU 23 belongs to. As shown in FIG. 8, the NM table is set for each zone ECU 22. However, for items other than the port number, all zone ECUs 22 have the same contents.

The end ECU_A and the end ECU_B identified by the node identification data belong to zone A, so the zone category is set to A. Further, since the end ECU_D and the end ECU_E belong to zone B, the zone category is set to B.

Focusing on the zone ECU_A, the end ECU_A belonging to the zone A is connected to the communication port P1 of the zone ECU_A, and the end ECU_B is connected to the communication port P2 of the zone ECU_A. The end ECU_D and end ECU_E belonging to zone B are connected to the zone ECU_B, which is connected to the communication port P4 of the zone ECU_A. Accordingly, in the NM table of the zone ECU_A, the port number associated with the end ECU_A is set to P1. The port number associated with the end ECU_B is set to P2. The port numbers associated with the end ECU_D and the end ECU_E are both set to P4.

Focusing on zone ECU_B, the end ECU_A and end ECU_B belonging to the zone A are connected to the zone ECU_A, and the zone ECU_A is connected to the communication port P1 of the zone ECU_B. Further, both the end ECU_D and the end ECU_E belonging to the zone B are connected to the communication port P2 of the zone ECU_B. Therefore, in the NM table of the zone ECU_B, the port numbers associated with the end ECU_A and the end ECU_B are both set to P1, and the port numbers associated with the end ECU_D and the end ECU_E are both set to P2.

### 2-3. Port Transfer

In each zone ECU 22a, the port forwarding processes in S270 and S330 in the message integration process executed by the calculation unit 224 shown in FIG. 5 are different from those in the first embodiment. That is, in the present embodiment, when the integrated NM message is transferred to each communication port, the NM table is used to extract the communication port that needs to be transferred, and the integrated NM message is transferred to the extracted communication port. Specifically, the logical AND of the integrated PN request information indicated in the integrated NM message and the PN filter information of all the end ECUs 23 indicated in the NM message is individually calculated. Then, the end ECU 23 whose calculation result is non-zero is extracted, and the integrated NM message is transferred only to the communication port indicated by the port number associated with the extracted end ECU 23.

### 2-4. Update Unit

The update unit 226 updates the NM table when a preset update condition is satisfied. The update condition may include adding a new end ECU 23, updating a program installed in the end ECU 23, acquiring update data of the NM table from the outside, and the like. In the present embodiment, the update unit 226 is placed separately from the calculation unit 224, but the update unit 226 may be implemented as a part of the process executed by the calculation unit 224.

As shown by a reference E1 in FIG. 7, a case where the new end ECU 23 (hereinafter referred to as end ECU_G) is connected to the transmission path 4 connected to the communication port P2 of the zone ECU_B will be described. When the end ECU_G is connected to the transmission path 4 and activated for some reason, it transmits an NM message including its own PN filter information as PN request information.

When the update unit 226 of the zone ECU_B refers to its NM table and detects that the information of the end ECU_G is not registered in the NM table, it adds the item of the end ECU_G to the NM table, as shown in the upper row of FIG. 9. This addition content is also transferred to the other zone ECUs 22, and each zone ECU adds an item of end ECU_G to the NM table. When an item of the end ECU_G is added to the NM table, in the zone ECU_B to which the end ECU 23 is added under its control, the zone category is set to the zone B to which it belongs, and the port number is set to P2 indicating the communication port that received the NM message.

The different zone ECU 22a that has received the update information (i.e., the item of the end ECU_G to be added) updates its NM table in accordance with the update information. Specifically, according to the zone category indicated in the update information, information is added to the NM table. The information includes information linking the port number of the communication port to which the zone ECU_B corresponding to the zone category is connected or to which the zone ECU_B reaches, with the item of the end ECU_G that is the update information.

As shown by the reference E2 in FIG. 7, a case will be described in which the PN filter information is changed by updating the program of the end ECU_D under the zone ECU_B. In this case, the end ECU_D transmits an NM message (hereinafter referred to as an update instruction) that includes the changed PN filter information and requests learning of the PNC (i.e., enables the PNL bit). In the zone ECU 22a that has received the update instruction, the update unit 226 updates the PN filter information for the end ECU_D that has been registered in its NM table, as shown in the lower part of FIG. 9, in accordance with the content of the update instruction. Further, the update unit 226 transfers the above update instruction to the different zone ECU 22a. Thereby, the NM table is updated in all the zone ECUs 22a.

Further, for example, when receiving update data of the NM table from the outside via the wireless device 3, the update unit 226 may update the NM table according to the received update data.

### 2-5. Effects

The second embodiment described in detail above provides the effects (1a) to (1c) described in the first embodiment and the following effect in addition.
(2a) The zone ECU 22a transfers the integrated NM message only to the communication port reaching the end ECU 23 that is the activation target by using the NM table. Accordingly, according to the in-vehicle network system 1a, it is possible to further reduce the amount of communication of NM messages.
(2b) According to the in-vehicle network system 1a, the NM table held by the zone ECU 22a is updated in response to the addition of the end ECU 23 or the update of the program. Therefore, it is possible to flexibly deal with system changes.

### 3. Third Embodiment

### 3-1. Difference from Second Embodiment

The fundamental configuration of the third embodiment is similar to that of the second embodiment. Therefore, the difference therebetween will be described below. The same reference numerals as in the first and second embodiments denote the same elements, and reference is made to the preceding description.

In the first embodiment described above, it has been described that there are two zone ECUs 22 to be relayed between the end ECUs 23, but there may be three or more zone ECUs 22 to be relayed. For example, there may be multiple hierarchically connected zone ECUs 22 in one zone.

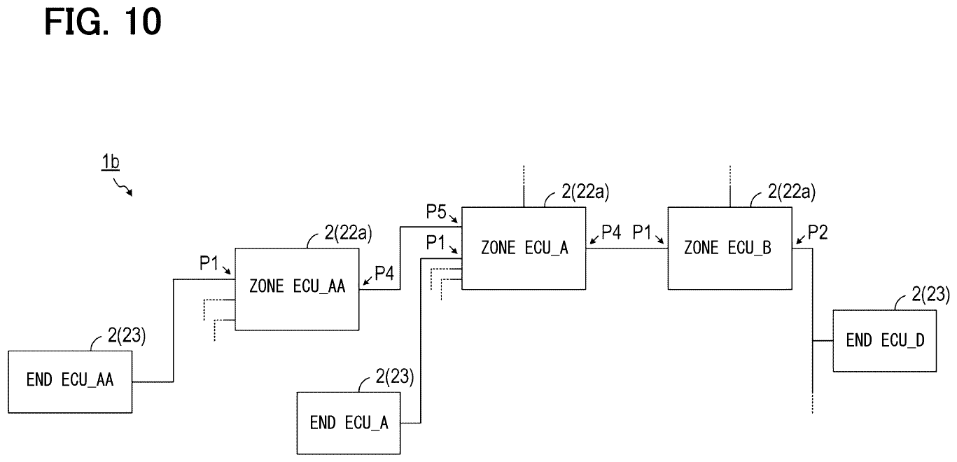

As shown in FIG. 10, an in-vehicle network system 1b includes a zone ECU_AA that controls a zone AA that is a part of zone A under the zone ECU_A, and an end ECU_AA under the zone ECU_AA. The zone ECU_AA is connected to the communication port P5 of the zone ECU_A. The zone ECU_A is connected to the communication port P4 of the zone ECU_AA, and the end ECU_AA is connected to the communication port P1 of the zone ECU_AA. The in-vehicle network system 1b is similar to the in-vehicle network system 1a of the second embodiment, except that the end ECUs 23 under the zone ECU_AA and the zone ECU_AA (only the end ECU_AA is shown in FIG. 10) are added. That is, in FIG. 10, a part of the central ECU 21, the zone ECU_C, and the end ECU 23 is omitted.

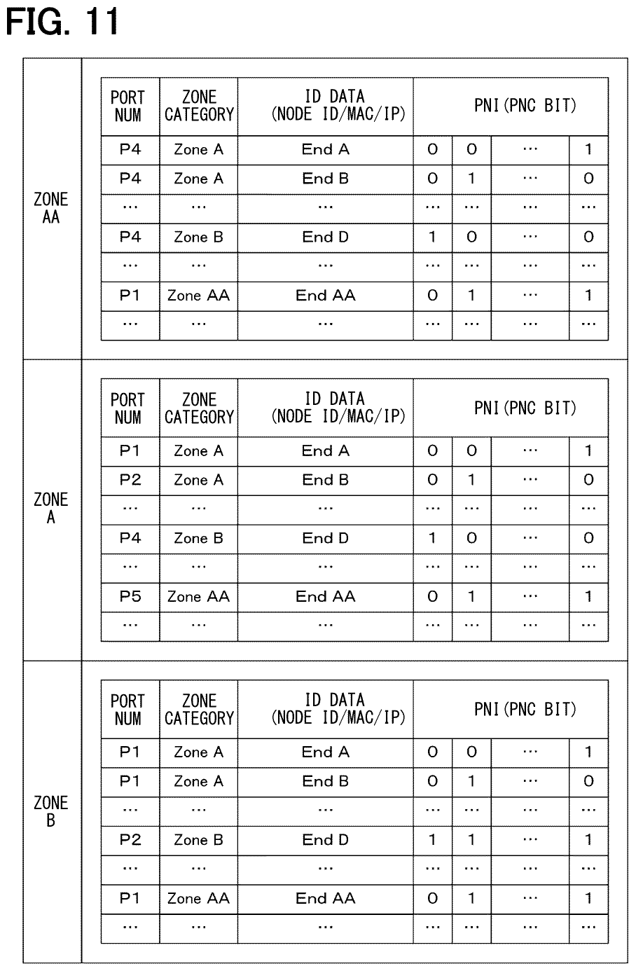

In the in-vehicle network system 1b shown in FIG. 10, the NM tables of the zone ECU_AA, the zone ECU_A, and the zone ECU_B are set as shown in FIG. 11. In the NM table of the zone ECU_AA, information about all end ECUs 23 connected to the different zone ECU 22 is associated with the port number P4. The zone category of the end ECU_AA is set to AA, and information about the end ECU_AA is associated with the port number P1.

In the NM tables of the zone ECU_A and the zone ECU_B, the information of the end ECU_AA is added to the contents shown in FIG. 8. However, the information of the end ECU_AA is associated with the port number P5 in the NM table of the zone ECU_A, and with the port number P1 in the NM table of ECU_B.

### 3-2. Operation Example

For example, when the end ECU_D transmits the NM message indicating the PN request information including a PN cluster of the end ECU_AA, the PN request information of the integration message generated in the zone ECU_B, of course, includes the PN cluster of the end ECU_AA. Accordingly, this integrated NM message is transferred to at least the communication port P1 in accordance with the information of the end ECU_AA in the NM table, and is received by the zone ECU_A.

The integrated NM message transferred to the zone ECU_A is retransmitted to at least the communication port P5 in accordance with the information of the end ECU_AA in the NM table of the zone ECU_A and received by the zone ECU_AA.

The integrated NM message transferred to the zone ECU_AA is re-transferred to at least the communication port P1 in accordance with the information of the end ECU_AA in the NM table of the zone ECU_AA, and is received by the end ECU_AA.

### 3-3. Effects

According to the third embodiment described above in detail, in addition to the effects (1a) to (1d) of the first embodiment and the effects (2a) and (2b) of the second embodiment, the following effect is also obtained.
(3a) In the in-vehicle network system 1b, the zone ECUs 22 have a hierarchical multi-stage connection structure. Therefore, for example, it is possible to implement a network structure suitable for vehicles with long lengths such as commercial trucks.

### 4. Other Embodiments

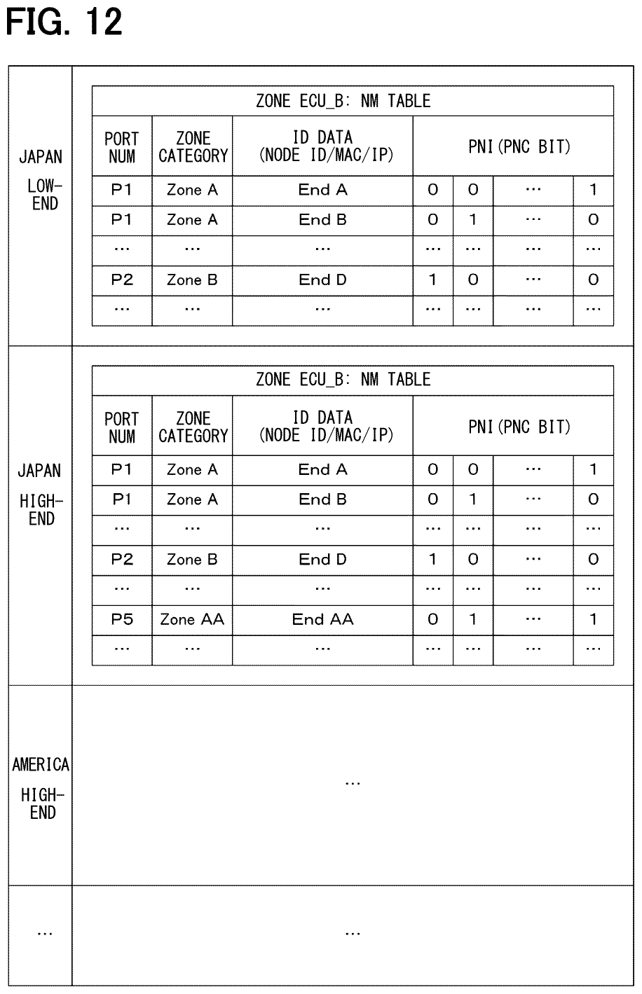

Although the embodiment of the present disclosure has been described above, the present disclosure is not limited to the above-described embodiments, and various modifications can be made.
(4a) In the above embodiments, the wireless device 3 is provided separately from the zone ECU 22, but the wireless device 3 may be built into any one or more zone ECUs 22.
(4b) In the above embodiments, the network aspect of connecting the zone ECU 22 and the subordinate end ECU 23 includes a mixture of a switched network and a bus network. However, the network aspect may be unified into any one of these network aspects.
(4c) In the embodiments described above, when the buffer congestion is detected, the buffering period is forcibly ended. Thereby, it is possible to prevent the NM message from being discarded due to the overflow of the reception buffer. Instead of buffering the NM message, the integrated NM message may be generated as follows to prevent the NM message from being discarded. That is, the NM request information is immediately extracted from the received NM message, and stored in a work area of the memory. Each time a new NM message is received, the work area storage content is updated based on a logical OR calculation result of the NM request information extracted from the received NM message and the NM request information stored in the work area. At the end of the buffering period, the integrated NM message may be generated using the NM request information stored in the work area, and transferred to each communication port. In this case, a new work area for updating the NM request information is required. However, since it is not necessary to store the entire received NM message during the buffering period, it is possible to prevent the overflow of the reception buffer from occurring.
(4d) In the above embodiment, each zone ECU 22a uses one NM table. On the other hand, as shown in FIG. 12, for example, multiple types of NM tables may be prepared in advance depending on the equipment situation of the vehicle with the in-vehicle network system 1a, such as the destination and the grade of the vehicle. In this case, for example, at the time of shipment, it is possible to select which NM table to use. The NM table may be selected by a dedicated physical switch or by an external instruction via the wireless device 3. Also, the equipment status of the vehicle may be identified from the information flowing through the in-vehicle network system 1a, and the NM table may be automatically selected.
(4e) The calculation units 224 and 234 and methods thereof described in the present disclosure may be implemented by a dedicated computer provided by configuring a processor and a memory programmed to execute one or more functions embodied by a computer program. Alternatively, the calculation units 224 and 234 and methods thereof described in the present disclosure may be implemented by a dedicated computer provided by configuring the processor with one or more dedicated hardware logic circuits. Alternatively, the calculation units 224 and 234 and methods thereof described in the present disclosure may be implemented by one or more dedicated computers configured with a combination of a processor and a memory programmed to execute one or more functions, and a processor configured with one or more hardware logic circuits. The computer program may be stored in a computer-readable non-transitory tangible storage medium as instructions to be executed by a computer. The methods of implementing the function of each part included in the calculation units 224 and 234 do not necessarily include software, and all the functions may be implemented using one or more pieces of hardware.
(4f) Multiple functions of one component in the above embodiment may be implemented by multiple components, or a function of one component may be implemented by the multiple components. Multiple functions of multiple configuration elements may be implemented by one configuration element, or one function implemented by multiple configuration elements may be implemented by one configuration element. Part of the configuration of the above embodiment may be omitted. Further, at least part of the configuration of the above-described embodiments may be added to or replaced with the configuration of another embodiment described above.
(4g) In addition to the above-described in-vehicle network system, the present disclosure can also be implemented in various forms, such as the zone ECU 22 and end ECU 23 which are components of the in-vehicle network system, a program for causing a computer to function as the zone ECU 22 or the end ECU 23, a non-transitory tangible storage medium such as a semiconductor memory on which this program is stored, and a method for transferring an activation message.

What is claimed is:

1. An in-vehicle network system comprising:
a plurality of relay nodes each including a plurality of communication ports; and
a plurality of end nodes each connected to one of the plurality of relay nodes,
wherein
each communication port of the plurality of relay nodes is connected to a different relay node among the plurality of relay nodes or an end node subordinated to the plurality of relay nodes among the plurality of end nodes, and
the plurality of end nodes include at least one of (i) a first circuit and (ii) a first processor with a first memory storing first computer program code executable by the first processor, the at least one of the first circuit and the first processor configured to cause the plurality of end nodes to:
transition from a sleep state to a wake-up state when an activation condition is satisfied inside at least one of the plurality of end nodes, and transmit an activation message including activation request information indicating an activation cluster to which the plurality of end nodes belong; and
transition from the sleep state to the wake-up state when receiving the activation message including the activation request information indicating the activation cluster to which the plurality of end nodes belong,
the plurality of relay nodes include at least one of (i) a second circuit and (ii) a second processor with a second memory storing second computer program code executable by the second processor, the at least one of the second circuit and the second processor configured to cause the plurality of relay nodes to:
merge the activation request information indicated in an integration target message that is the activation message received from, among the plurality of end nodes, a subordinate end node during a predetermined buffering period to generate integration activation request information;
generate an integration activation message that is the activation message including the integration activation request information; and
transfer the generated integration activation message to, among the plurality of communication ports, a communication port other than a communication port that received the integration target message.

2. The in-vehicle network system according to claim 1, wherein
each relay node includes an activation table,
the activation table includes, for all of the plurality of end nodes,
information for identifying each end node,
activation filter information for listing the activation cluster to which the plurality of end nodes belong,
information for identifying the plurality of relay nodes connected to the plurality of end nodes, and
information indicating the plurality of communication ports individually reaching the plurality of end nodes, and
the at least one of the second circuit and the second processor is further configured to cause the relay node to
compare the activation request information indicated in the integration activation message with the activation filter information indicated in the activation table to identify, among the plurality of end nodes, an end node indicated by the activation request information; and
transfer the integration activation message to all the communication ports reaching the identified end node.

3. The in-vehicle network system according to claim 2, further comprising
the at least one of the second circuit and the second processor is further configured to cause the plurality of relay nodes to update the activation table when a predetermined update condition is satisfied.

4. The in-vehicle network system according to claim 3, wherein
the update condition includes receiving the activation message from, among the plurality of end nodes, an end node that is not registered in the activation table.

5. The in-vehicle network system according to claim 3, wherein
the update condition includes receiving an update instruction indicating update data of the activation table from, among the plurality of end nodes, an end node registered in the activation table.

6. The in-vehicle network system according to claim 3, wherein
the update condition includes acquiring update data of the activation table from an outside of the in-vehicle network system.

7. The in-vehicle network system according to claim 2, wherein
the activation table includes a plurality of types of activation tables,
the plurality of relay nodes include the plurality of types of activation tables, and
the at least one of the second circuit and the second processor is further configured to cause the plurality of relay nodes to serve as to select and use one of the plurality of types of activation tables according to an equipment device status of a vehicle with the in-vehicle network system.

8. A relay node forming an in-vehicle network system with a different relay node and a plurality of end nodes, the relay node comprising:
a plurality of communication ports connected to the different relay node or an end node subordinated to the relay node among the plurality of end nodes; and
at least one of (i) a circuit and (ii) a processor with a memory storing computer program code executable by the processor, the at least one of the circuit and the processor configured to cause the relay node to:
merge activation request information indicated in an integration target message that is an activation message received from, among the plurality of end nodes, a subordinate end node during a predetermined buffering period to generate integration activation request information;
generate an integration activation message including the activation request information; and
transfer the generated integration activation message to, among the plurality of communication ports, a communication port other than a communication port in which the integration target message is received,
wherein
the activation request information is information indicating an activation cluster to which an end node that is a transmission source of the activation message belongs among the plurality of end nodes, and
the activation message is transmitted from, among the plurality of end nodes, at least one end node when a predetermined activation condition is satisfied in the at least one end node, and among the plurality of end nodes, a reception end node transitions from a sleep state to a wake-up state when the activation cluster to which the reception end node that received the activation message belongs is indicated in the activation request information included in the activation message.

9. A transfer method of an activation message in a relay node forming an in-vehicle network system with a different relay node and a plurality of end nodes, the relay node comprising a plurality of communication ports connected to the different relay node or an end node subordinated to the relay node among the plurality of end nodes, the method comprising:
merging activation request information indicated in an integration target message that is the activation message received from, among the plurality of end nodes, a subordinate end node during a predetermined buffering period to generate integration activation request information, and
generating an integration activation message including the activation request information; and
transferring the generated integration activation message to, among the plurality of communication ports, a communication port other than a communication port that received the integration target message,
wherein
the activation request information is information indicating an activation cluster to which an end node that is a transmission source of the activation message belongs among the plurality of end nodes, and
the activation message is transmitted from, among the plurality of end nodes, at least one end node when a predetermined activation condition is satisfied in the at least one end node, and the method further includes causing, among the plurality of end nodes, a reception end node to transition from a sleep state to a wake-up state when the activation cluster to which the reception end node that received the activation message belongs is indicated in the activation request information included in the activation message.
